(19) United States
(12) Patent Application Publication
(10) Pub. No.: US 2005/0086131 A1
(43) Pub. Date: Apr. 21, 2005

(54) System for tactile properties assessment

(76) Inventor: Nicola Julia Davison, Nottingham (GB)

Correspondence Address: Galgano Burke, Suite 35, 300 Rabro Drive, Hauppauge, NY, 11788, US

(21) Appl. No.: 10/688,457

(22) Filed: Oct. 17, 2003

(51) Int. Cl. G06F 17/60

(52) U.S. Cl. 705/27

(57) ABSTRACT

A system for enabling the tactile properties of an article—for example an article of clothing—to be assessed, comprises a display unit displaying a first image of the article, and displaying electronically, at least one further image, which is visually representative of a particular tactile property of the article such as softness, density, thermal property, thickness, hairiness, prickliness, drape, deformability, elasticity, crispness and smoothness.

### FIELD OF THE INVENTION

The invention relates to a system for enabling the tactile properties of an article—for example an article of clothing—to be assessed.

### BACKGROUND TO THE INVENTION

Electronic commerce has been successful particularly in areas where the purchasing decision is dependent on written information. This is a case for example for on-line theatre bookings, flight bookings and book purchases. Electronic commerce has also been successful in the music industry where the purchaser has access to music samples of interest. Generally, electronic commerce has had its greatest success in fields where the purchase decision relies primarily on written information and where the purchasing decision relies on a combination of written information and sound.

When it comes to on-line purchasing of articles of clothing or motor vehicles, the current web sites are no substitute for either the high street or the show room. Nevertheless, many companies have on-line catalogues allowing on-line purchases to be carried out. These are however simply electronic forms of the well known glossy paper catalogues and offer little more than a single picture of a given article with its measurement. It is only once the article is delivered to the purchaser that he/she is able to assess its tactile properties.

In the high street, the purchaser usually handles a given article in order to feel its properties. Certain purchases will also rely on a number of certification marks which often accompany articles of clothing in order to indicate a particular level of quality. On many shoe boxes for example there is shown an image of the shoe on the outside of the box alongside a genuine leather certification mark. The purchaser may look at these two images to assess the tactile property of the shoe. This means of indicating tactile property is of course superseded by the actual purchaser touching and handling for themselves the product and arriving at a purchasing decision based on his/her assessment of that property.

Currently research and development is developing systems which may convey the tactile properties of an article by electronically triggered mechanical devices which may for example vibrate at certain frequencies to convey a particular sensation to a user which would be in contact with the device. These systems have not been fully developed yet but when they are they would allow a purchaser to assess the tactile properties of an article on-line. However, these systems would require each purchaser to acquire the device for transmitting vibration. These would therefore not allow standard computers to be readily employed in the assessment of the tactile properties of articles.

In summary, it is generally considered that electronic commerce is only primarily successful when the purchasing decision is based on written and sound information and that there is no system which allows a purchaser to assess the tactile properties of an article on-line because it is generally believed that tactile properties can only be assessed through direct physical contact with either the actual article or with a mechanical simulating device.

The primary objective of the present invention is to introduce a system which may be used on all currently available computers to allow the tactile properties of an article to be assessed.

### SUMMARY OF THE INVENTION

In its broadest aspect, the invention provides a system for enabling the tactile properties of an article—for example an article of clothing—to be assessed, comprising a display unit combining means for displaying a first image of the article, with means of triggering, and displaying electronically, at least one further image, which is visually representative of a particular tactile property of said article such as softness, density, thermal property, thickness, hairiness, prickliness, drape, deformability, elasticity, crispness and smoothness.

This combination of features marks a complete departure from the conventional thinking that tactile properties of an article may not be correctly conveyed via images. This system will have the benefit of not requiring any expensive hardware to be purchased for each display unit. This system will allow electronic commerce to have a greater appeal particularly in the fields where decisions are based on tactile properties.

In a subsidiary aspect in accordance with the broadest aspect of the invention, said further image includes an indication of the scale to which the article possesses the said property sufficient to enable the article to be compared with other articles possessing the same property.

Providing a further image which includes an indication of the scale will even further improve the quality of the assessment and further contribute to removing the perceived barriers of on-line purchasing where tactile properties are an essential element in the decision making process of a purchaser.

In a further subsidiary aspect, the further image is a close-up view of the article and the system comprises means for triggering an animation of a region of said article giving the impression to the viewer that the article is touched at said region and pressed inwardly and means for varying the extent to which said region appears to be pressed inwardly dependent on the actual density of said article.

This combination of features will enable a purchaser to assess more readily the density, thickness or fullness properties of an article.

In a further subsidiary aspect, the further image shows the contour of the article and the photography settings are arranged to highlight the contour, whereby when the article is of actual high softness the width of the highlighted contour is greater than when said article is of actual low softness. The advantage of these particular features is that softness may be assessed by the viewer.

In a further subsidiary aspect, the further image comprises an animation with an object whose density of colour pixels gradually radially decreases and means are provided to vary the rate at which the density of colour pixels decrease dependent on the actual softness of said article. These features will further improve the transmission to a viewer of the tactile property of softness.

In a further subsidiary aspect, the further image comprises an animation with an object whose density of colour pixels gradually radially decrease and which is set to displace following a path of varying length dependent on the actual softness of said article.

In a further subsidiary aspect, the further image comprises an animation with an object whose density of colour pixels gradually radially decrease and which is set to displace at a velocity dependent on the actual softness of said article.

In a further subsidiary aspect, means are provided to trigger an animation displaying a number of filaments which bend to varying degrees dependent on the actual hairiness of said article. This particular feature will improve the way in which a viewer may assess the hairiness of a given article.

In a further subsidiary aspect, means are provided which respond to the position of a cursor over the image to trigger varying degrees of bending of said filaments. This feature will improve the quality of the assessment by giving the viewer the impression that he/she is actually stroking the article.

In a further subsidiary aspect, means are provided to trigger an animation displaying a number of filaments which buckle to varying degrees dependent on the actual prickliness of said article.

This particular feature will allow the transmission of the prickliness feeling through a display unit to its viewer.

In a further subsidiary aspect, means are provided which respond to the position of a cursor over the image to trigger varying degrees of buckling of said filaments. This is particularly advantageous because it allows the viewer to perceive that he/she is interacting with the article.

In a further subsidiary aspect, the further image containing an array of objects whose colour contrasts with the colour of said article which are visible at different frequencies and the array is of varying density dependent on the actual extent of prickliness of said article. This combination of features is a particular practical advantageous form of conveying to a viewer the prickliness sensation without requiring any expensive hardware, i.e. simply through the display unit.

In a further subsidiary aspect, the further image is an article of clothing draped over an object and associated with an animation of a wave form of varying frequencies dependent on the actual drape properties of said article. In this particular form, drape properties are transmitted to a viewer without requiring the use of expensive hardware.

In a further subsidiary aspect, a sequence of further images show an article at various stages of folding whereby the viewer is able to assess the thickness of the article.

In a further subsidiary aspect, a sequence of further images are stored which show the article under different levels of stretching, whereby the viewer is able to assess the extent to which the article may be stretched.

In a further subsidiary aspect, the further image is a line which extends to a greater or lesser extent dependent on the article's actual elasticity.

In a further subsidiary aspect, there are provided at least two other images, whereby the first image is a common geometric shape such as a square and the second is an image of the shape as if having been submitted to a deforming system of forces, whereby the extent of deformation shown varies dependent on the article's deformability. In this configuration deformability is able to be assessed by a viewer.

In a further subsidiary aspect, there is provided a thermometer image with a mercury line rising to varying degrees dependent on the article's thermal properties. This will allow the thermal property of an article to be assessed in a readily understandable form without requiring the use of physical temperature conveying means.

In a further subsidiary aspect, there is provided a view of the article and an object which displaces along a line at varying degrees of velocities dependent on the actual smoothness of the article. This will provide the viewer (or purchaser) with an indication of the level of smoothness of an article.

In a further subsidiary aspect, the article in said view comprises a fold line along which the object displaces. This will accentuate the perceived level of smoothness of an article and therefore improve the quality of the assessment of a viewer (or purchaser) of the article.

In a further subsidiary aspect, one of said images is coupled with a sound track representative of one of the article's tactile properties.

### BRIEF DESCRIPTION OF THE FIGURES

FIG. 1 shows a schematic view of a web-page according to one embodiment of the invention.

FIG. 2 schematically shows a group of filaments according to a further embodiment of the invention used to represent a tactile property.

FIG. 3 schematically shows a group of filaments according to a further embodiment of the invention used to represent a further tactile property.

FIG. 4 shows an image representative of a further tactile property.

FIG. 5 shows an image representative of a further tactile property.

FIG. 6 shows an image representative of a further tactile property.

FIG. 7 shows an image representative of a further tactile property.

FIG. 8 shows an image representative of a further tactile property.

FIG. 9 shows a succession of images representative of a further tactile property.

FIG. 10 shows an image representative of a further tactile property.

FIG. 11 shows an image representative of a further tactile property.

### DETAILED DESCRIPTION OF THE FIGURES

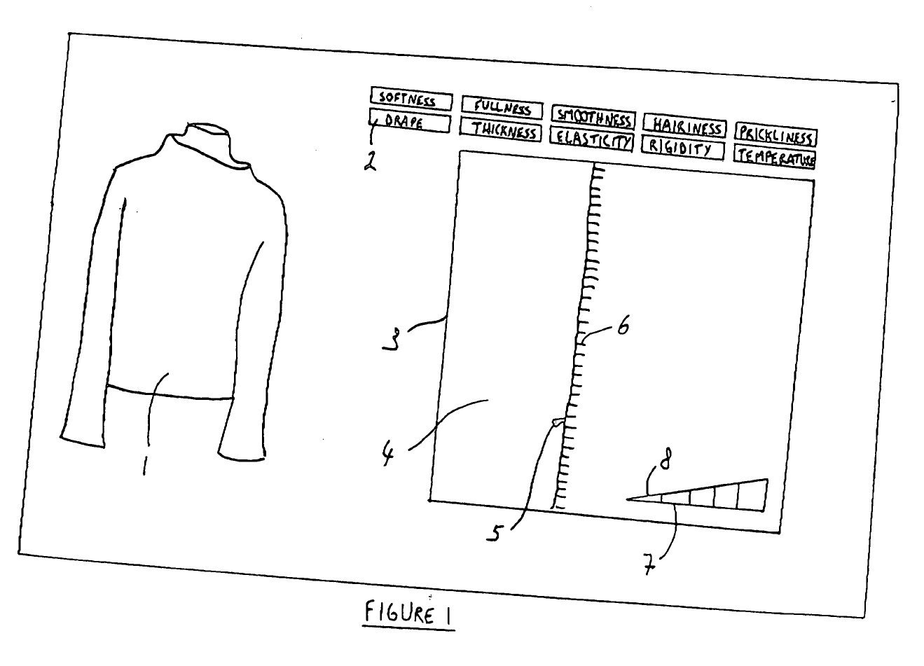

FIG. 1 shows an illustration of a web page showing an article of clothing generally referenced 1 whose tactile properties are to be assessed by a viewer. The web page may be configured using as appropriate either any standard web design software package or a programming language. The web page comprises a number of buttons such as that referenced 2 which may react to the cursor being located over the button to trigger the display of a further image of the article in box 3. The tactile properties which this system allows to display are: softness, fullness, smoothness, hairiness, prickliness, drape, thickness, elasticity, rigidity and temperature. The system is not limited to necessarily having all of these buttons. The web page may for example permit the assessment of only a single tactile property of an article such as temperature. Visually representing each of these tactile properties will naturally provide the viewer or would-be purchaser with a more complete picture of the properties of the article of clothing.

Box 3 shows a close-up view in schematic form of a portion 4 of an article of clothing 1. The close-up shows the contour region 5 of the article of clothing. The photography parameters may be selected as appropriate by the person skilled in the art. The lighting may be chosen to accentuate the contour region 5 so as to allow the viewer to identify filaments 6 protruding from the article at region 5.

Additional filament objects may be chosen to appear at the contour region and may be of different lengths and set to animate to convey to the viewer the sensation of hairiness and/or prickliness. If the article of clothing may be defined as highly prickly i.e. an article of clothing whose hairs are thick and rigid, an animation may be triggered by the position of the cursor on the screen which shows a simulation of the would-be movement of the hair should a finger of the user be pressed against the hairs. If it is classed as highly prickly little or no motion may be displayed to convey the feeling of prickliness to the viewer.

The image of box 3 is displaying particularly the hairiness property of the article of clothing. Filaments 6 are short to indicate that the article of clothing is not particularly hairy.

A triangular object 7 is provided to further emphasise the scale to which the article possesses the property of hairiness. Since only the first triangular portion 8 of the triangular object is coloured, the viewer will immediately see that the article of clothing is of low hairiness. Had the article of clothing been of great hairiness all five triangular portions would have been coloured-in.

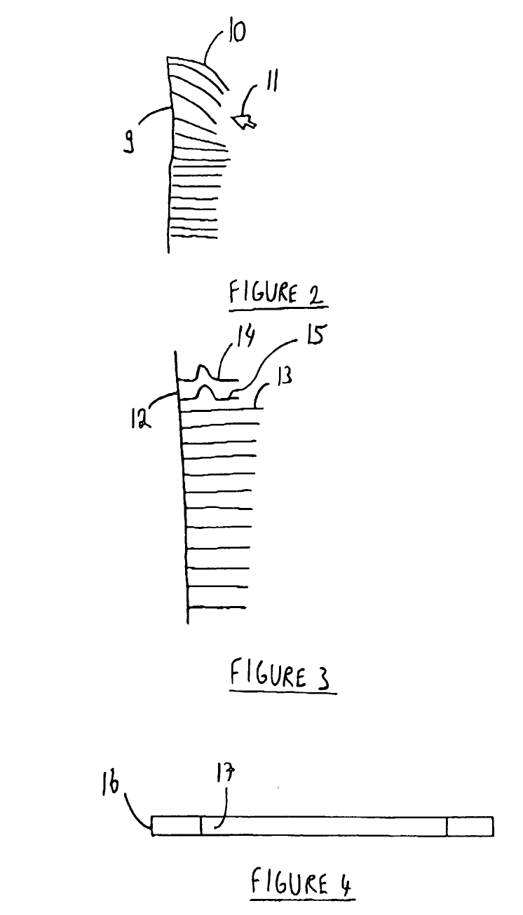

FIG. 2 illustrates an animation which may be used to show the degree of hairiness of a particular article of clothing. There is presented an article's contour 9 from which a number of filaments 10 protrude and are set to bend to varying degrees dependent on the position of cursor 11. This animation in effect simulates the movement of a finger of the viewer over the surface of an article.

FIG. 3 also illustrates the contour 12 of an article with a number of filaments 13 which instead of bending as was the case for the filaments of FIG. 2, buckle in reaction to the position of a cursor. Two buckled filaments 14 and 15 can be seen in the Figure. Buckling may take the form of a slight bowing of the filaments when the article possess a high degree of prickliness.

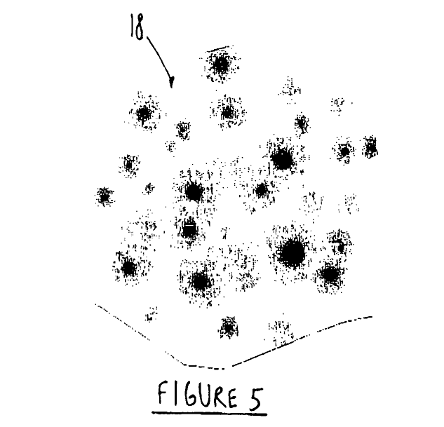

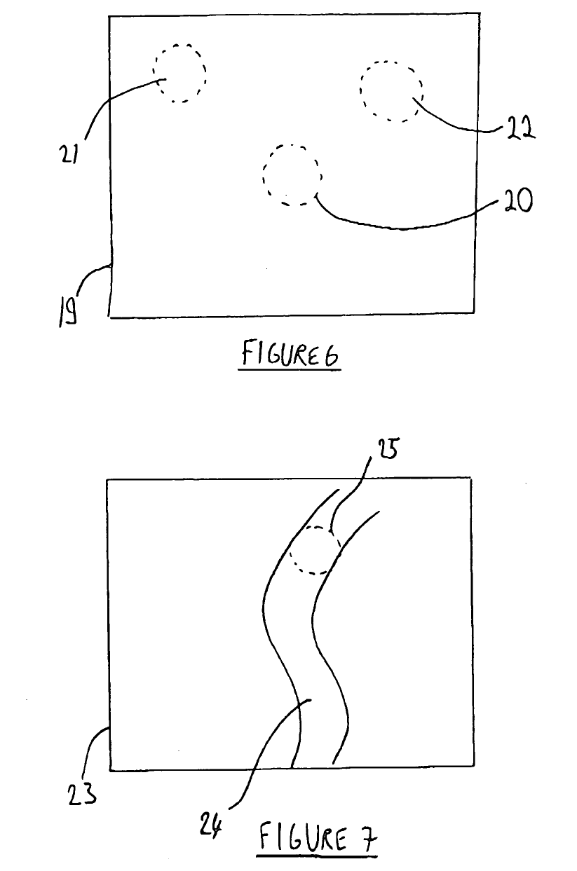

FIG. 4 illustrates an animation which may be triggered by pressing the elasticity button of the web site. The animation is a rectangular strip 17 which varies in length within a rectangular box 16 to varying degrees dependent on the level of elasticity that an article possesses.

The invention also envisages the use of an animation which allows the viewer to pull the fabric by pressing down and dragging the mouse to cause the viewing of a succession of images which show the stretching and then springing back of the article of clothing to its original shape.

In order to visually present the tactile property of the softness, the use of soft circles that fade away at the edges is envisaged. When the viewer presses the button entitled softness a further image appears showing a close-up view of a region of the article. An animation is linked to its image with an array of soft circles whose density of colour pixels gradually radially decrease. Each circle of the array 18 may be set to only be visible when the cursor of the mouse if passed over a particular circle. This animation would contribute to the transmission of the feeling of softness to the interacting viewer. It is also envisaged that the individual circles may change in dimensions at different speeds to give the viewer a greater impression of softness of the article.

In order to emphasise the extent of softness the further image may also simply be a close-up view of an article of clothing under soft lighting in order to highlight the contour of the article so that the highlighted contour is of greater or lesser width dependent on the article's actual softness.

The system also envisages having an object which would follow a path of say a triangular configuration. The size of the triangular path may be varied and the velocity of the displacement of the object may be varied dependent on the level of softness possessed by the article.

The fullness or density of material may be presented by capturing a succession of images showing the likely displacement of an article when touched at a given region and pressed inwardly. In practice this may be achieved by showing a close-up image of an article of clothing in box 19 and associating with that close-up image an object such as that schematically presented at 20, within which an even further close-up image may be viewed when the cursor is passed over said object. This would give the viewer the impression that at said object 20 the article is touched and pressed inwardly. The extent of the close-up view in object 20 will be varied dependent on the actual density/fullness of the article. Whilst an object 20 has been provided and located at the centre of the image contained in box 19 other objects 21 and 22 may be provided and animated in a similar manner to object 20.

It is also envisaged that the further image is animated wherever the cursor of the mouse is located to give the viewer the impression that the article is touched and pressed inwardly at any location of the cursor over the image of the article. This would allow the system to more closely simulate the pressing of an article by the viewer.

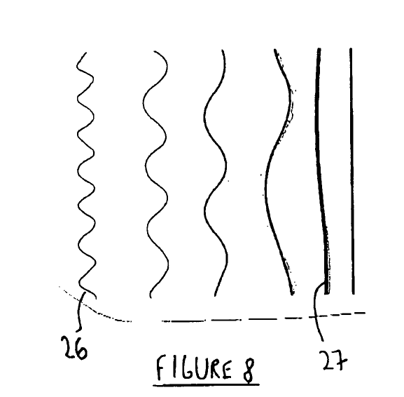

FIG. 7 shows a further image contained in box 23 showing a fold 24 in an article of clothing. Photography may be used to show the light reflection which is often present in smooth fabrics such as silk. In order to emphasise this characteristic, soft and hard light photography techniques may be combined to improve the image.

An animation is envisaged which shows the distortion of the fabric by changing the way the light is reflected from the fabric.

It is also envisaged to use an object such as that referenced 25 which appears to glide along the fold line 24. It is envisaged that the object may displace along the fold line of the fabric of the article at different velocities. The slower displacement of the object the less smooth would be the article.

It is also envisaged that the object may be dragged across the image by using the cursor of the mouse and that the object may more or less resist displacement dependent on the smoothness of the article.

With regard to displaying an image which would be visually representative of drape, the further image may be the image of the article of clothing as draped over a cylinder.

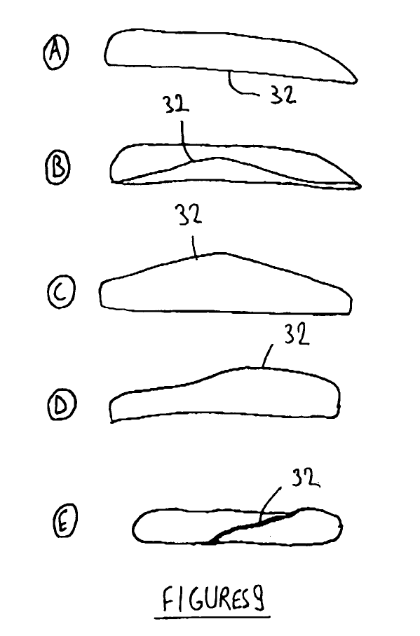

An animation may also be used to illustrate the manner in which an article drapes. The animation may be a sinusoidal wave length of varying frequency and amplitude. For example, as shown in FIG. 8, a variety of wave forms may be employed. Wave length 26 would be typical of an article with high drape whilst the wave length 27 would be typical of an article with low drape. The animation may also be a succession of images showing the article being swung in a pendulum motion.

With regard to the representation of the property of thickness one particular animation has been envisaged and is schematically illustrated in FIG. 9. FIG. 9a shows the side of an article placed on a flat surface and viewed from the side. Edge 32 is shown in successive FIGS. 9a to 9e at various stages of folding where in this particular case the edge is lifted up in FIGS. 9a to 9c and left to fall back onto its supporting flat surface (not illustrated in the figure for clarity) as can be seen in FIGS. 9d to 9e. In FIG. 9e, a portion of the article ends up as partially folded back on itself. By successfully showing these images at varying frequencies, the thickness of the article may be readily assessed by the viewer of the animation.

It is envisaged that the animation may be of an article of clothing being picked up. The picking up of the article would be triggered by the position of the cursor. The resistance through the pick-up may be varied in accordance with the actual weight and thickness of the article.

A further method of illustrating the thickness of an article would be to show a close-up view of the edge of the article so that the user could directly identify the actual thickness of the fabric.

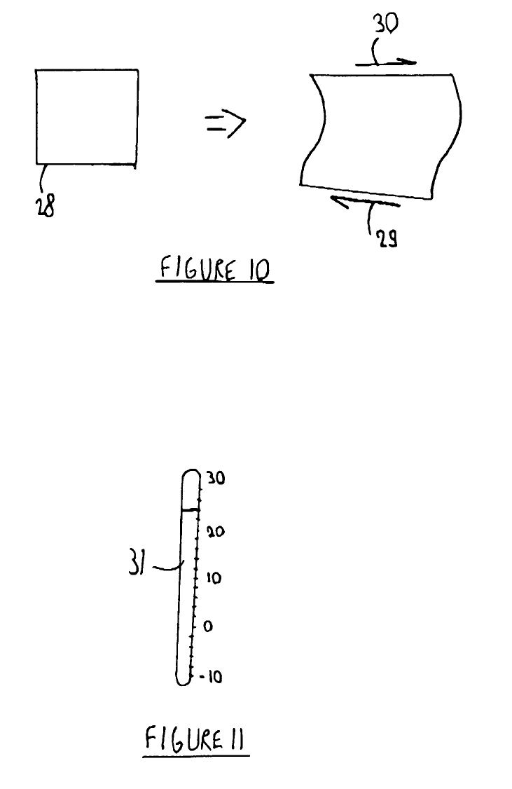

FIG. 10 illustrates the animation used in order to show the rigidity of an article of clothing. Generally, rigidity is a measure of the resistance of the materials to bending by external forces. A rigid fabric will usually hold its shape and have very little or no distortion, a non-rigid fabric will feel floppy and distort easily. One manner to illustrate rigidity is to show a portion of an article such as that referenced 28 and showing the image of a portion of the article after having been distorted by forces such as those referenced 29 and 30. The system of forces 29 and 30 has in effect applied a shear force on portion 28. By varying the extent to which this kind of distortion occurs, a measure of the rigidity of an article may be assessed.

FIG. 11 shows an example of a further image which may be displayed for a given article to illustrate its thermal properties. This is in effect a mercury line referenced 31 whose height depends on the thermal properties of the article. It is also envisaged that the mercury line may be either blue or red to further emphasise the extent of its thermal property.

The tactile property of crispness may be transmitted electronically by showing either two images or portions of articles moving against each other and a simulation of the actual sound that such movement would generate. The characteristics such as frequency, noise and volume of the sound would be varied in order to allow a user to assess the crispness of the article.

In the foregoing embodiments, the invention has been described with specific reference to articles of clothing. The invention however is not limited to articles of clothing alone but may apply to any article whose tactile properties require this kind of assessment. It is particularly envisaged that this system may be of use in presenting the tactile properties of the inside of vehicles such as seats and steering wheels. It may also be used to assess DIY products such as sand paper etc. The scope of the invention is defined in the claims that now follow.

1. A system for enabling the tactile properties of an article—for example an article of clothing—to be assessed, comprising a display unit combining means for displaying a first image of the article, with means for triggering, and displaying electronically, at least one further image, which is visually representative of a particular tactile property of said article such as softness, density, thermal property, thickness, hairiness, prickliness, drape, deformability, elasticity, crispness and smoothness.

2. A system according to claim 1, wherein said further image includes an indication of the scale to which the article possesses the said property sufficient to enable the article to be compared with other articles possessing the same property.

3. A system according to claim 1, wherein the further image is a close-up view of the article and the system comprises means for triggering an animation of a region of said article giving the impression to the viewer that the article is touched at said region and pressed inwardly and means for varying the extent to which said region appears to be pressed inwardly dependent on the actual density of said article.

4. A system according to claim 1, wherein the further image shows the contour of the article and the photography settings are arranged to highlight the contour, whereby when the article is of actual high softness the width of the highlighted contour is greater than when said article is of actual low softness.

5. A system according to claim 1, wherein the further image comprises an animation with an object whose density of colour pixels gradually radially decreases and means are provided to vary the rate at which the density of colour pixels decrease dependent on the actual softness of said article.

6. A system according to claim 1, wherein the further image comprises an animation with an object whose density of colour pixels gradually radially decrease and which is set to displace following a path of varying length dependent on the actual softness of said article.

7. A system according to claim 1, wherein the further image comprises an animation with an object whose density of colour pixels gradually radially decrease and which is set to displace at a velocity dependent on the actual softness of said article.

8. A system according to claim 1, wherein means are provided to trigger an animation displaying a number of filaments which bend to varying degrees dependent on the actual hairiness of said article.

9. A system according to claim 8, comprising means which respond to the position of a cursor over the image to trigger varying degrees of bending of said filaments.

10. A system according to claim 1, wherein means are provided to trigger an animation displaying a number of filaments which buckle to varying degrees dependent on the actual prickliness of said article.

11. A system according to claim 10, comprising means which respond to the position of a cursor over the image to trigger varying degrees of buckling of said filaments.

12. A system according to claim 1, wherein the further image containing an array of objects whose colour contrasts with the colour of said article which are visible at different frequencies and the array is of varying density dependent on the actual extent of prickliness of said article.

13. A system according to claim 1, wherein the further image is of an article draped over an object and associated with an animation of a wave form of varying frequencies dependent on the actual drape properties of said article.

14. A system according to claim 1, wherein a sequence of further images show an article of clothing at various stages of folding, whereby the viewer is able to assess the thickness of the article.

15. A system according to claim 1, wherein a sequence of further images are stored which show the article under different levels of stretching, whereby the viewer is able to assess the extent to which the article may be stretched.

16. A system according to claim 1, wherein the further image is a line which extends to a greater or lesser extent dependent on the article's actual elasticity.

17. A system according to claim 1, wherein there are provided at least two further images, where the first image is a common geometric shape such as a square and the second is an image of the shape as if having been submitted to a deforming system of forces, whereby the extent of deformation shown varies dependent on the article's deformability.

18. A system according to claim 1, wherein there is provided a thermometer image with a mercury line rising to varying degrees dependent on the article's thermal properties.

19. A system according to claim 1, wherein there is provided a view of the article and an object which displaces along a line at varying degrees of velocities dependent on the actual smoothness of the article.

20. A system according to claim 17, wherein the article in said view comprises a fold line along which the object displaces.

21. A system according to claim 1, wherein the further image is coupled with a sound track representative of one of the article's tactile properties.
